(19) United States
(12) Patent Application Publication
(10) Pub. No.: US 2006/0196093 A1
(43) Pub. Date: Sep. 7, 2006

(54) Detachable bezel for footwear and the like

(75) Inventor: Brian Krauss, Saddle River, NJ (US)

Correspondence Address: GOTTLIEB RACKMAN & REISMAN PC, 270 MADISON AVENUE, 8TH FLOOR, NEW YORK, NY, 100160601, US

(73) Assignee: Sneaker Luxe LLC

(21) Appl. No.: 11/218,362

(22) Filed: Sep. 2, 2005

Related U.S. Application Data
(60) Provisional application No. 60/658,019, filed on Mar. 2, 2005.

(51) Int. Cl. G09F 23/00

(52) U.S. Cl. 40/636

(57) ABSTRACT

A removable and decorative bezel is selectively fixed to an item of footwear, for example, along the side of the shoe or along the tongue. The location to which the bezel is removably attached has a metal ring fixed to the shoe material. The ring is formed with an outer annular flange thereabout that is formed with a plurality of holes. The ring is sewn to the leather by stitching running through the holes of the flange.

### BACKGROUND OF THE INVENTION

This application is based upon and claims priority of provisional application No. 60/658,019, filed Mar. 2, 2005.

This invention relates to a removable and decorative bezel and, more particularly, to a removable and decorative bezel that may be selectively fixed to an item of footwear or other apparel item.

In the past, there have been various attempts to produce apparel items, such as shoes and sneakers, which have logos or designs that are secured to the apparel item, but which can be readily removed and replaced. Such attempts include forming pockets, constructing a metal frame formed with an opening, or forming a window of some type in the apparel item. Each of these types of designs are less than desirable as they require the apparel item to be specially constructed.

Accordingly, it would be desirable to provide a system which overcomes the above disadvantages.

### SUMMARY OF THE INVENTION

A removable and decorative bezel is selectively fixed to an apparel or accessory item, such as an item of footwear. The location to which the bezel is removably attached has a metal ring fixed to the material of the apparel or accessory item. The ring is formed with an outer annular flange thereabout that is formed with a plurality of holes. The ring is sewn to the material by stitching running through the holes of the flange.

The removable bezel may be rotatably screwed on and off the fixed ring (formed with annular threads for accommodating the bezel) as needed, depending upon whether the wearer desires the bezel to be present. The bezel can contain some type of decorative design, including, for example, an arrangement of precious, semi-precious or costume (jewelry) stones, or can contain lettering such as the letters of a trademark or even a logo, or both stones and letters. A plurality of bezels may be selectively attached to a single apparel or accessory item and bearing different designs/visual impressions so that the wearer can present a variety of looks.

In accordance with the invention, a plurality of bezels may be interchangeable between an accessory item and an apparel item, such as between a watch and an item of footwear, that, together, are sold as a unit, or that are sold separately, but come from the same source of the goods. For example, the stone bezel of a brand name can be removed from a watch and attached to a shoe and vice versa.

While the inventive concept, in its preferred form, is envisioned for footwear, it is equally applicable to clothing, leather goods (bags and the like), etc. Accordingly, a bezel on a handbag can be removed and placed on a shoe, or on a watch. A different bezel can therefore be placed where one has been removed.

Accordingly, it is an object of the invention to provide a removable and decorative bezel which may be selectively fixed to an item of footwear or other apparel or accessory item.

Still another object of the invention is to provide a plurality of bezels that are interchangeable between different apparel or accessory items.

Yet a further object of the invention is to provide a removable bezel system in which the bezel contains some type of decorative design.

Still other objects and advantages of the invention will, in part, be obvious and will, in part, be apparent from the following description.

The invention accordingly comprises articles of manufacture possessing the features, properties and the relation of elements which will be exemplified in the articles hereinafter described, and the scope of the invention will be indicated in the claims.

### BRIEF DESCRIPTION OF THE DRAWINGS

FIG. 1 is a top plan view of a removable and decorative bezel of the invention with the top surface thereof being shown with a logo design imprinted thereon;

FIG. 2 is a bottom plan view of the inventive removable and decorative bezel;

FIG. 3 is a top plan view of a ring used with the inventive bezel;

FIG. 4 is a bottom plan view of the ring shown in FIG. 3;

FIG. 5 is a top plan view of the removable and decorative bezel of the invention rotatably screwed onto the ring depicted in FIGS. 3 and 4;

FIG. 6 is a cross-sectional view showing the rotating inter-engagement between the removable and decorative bezel of the invention depicted in FIGS. 1 and 2 and the metal ring depicted in FIGS. 3 and 4;

FIG. 7 is an enlarged front view of the ring of FIGS. 3 and 4 shown sewn to a fabric or other attachable material;

FIG. 8 is an exploded perspective view of the inventive bezel being rotatably screwed onto the ring which has mounted onto the fabric or other material shown in FIG. 7;

FIG. 9 is a front perspective view of the removable and decorative bezel of the invention rotatably mounted along the tongue of a sneaker;

FIG. 10 is a side elevational view of the inventive bezel rotatably mounted along the side wall of a sneaker;

FIG. 11 is a perspective view showing the inventive bezel rotatably mounted along the front portion of a pocketbook;

FIG. 12 is a front elevational view showing the decorative bezel of the invention rotatably mounted along the pocket of a clothing item; and

FIG. 13 is an exploded perspective view showing the inventive bezel being rotatably mounted along the case of a watch assembly.

### DETAILED DESCRIPTION OF THE PREFERRED EMBODIMENTS

Referring first to FIG. 1, a removable and decorative bezel made in accordance with the invention and generally indicated at 101 is shown. Bezel 101 has a ring-like configuration for defining a circular opening 104 and a top surface 103 with the lettering 105 imprinted therealong. In accordance with the invention, top surface 103 of bezel 101 may have no decorative features, or may instead have lettering (as shown), stones or some other decorative visual presentation, any of which can be applied, for example, along top surface 103 by conventional mean (engraving, etc.). The bezel may also have decorative elements, such as stones or letters, on the side surface 108.

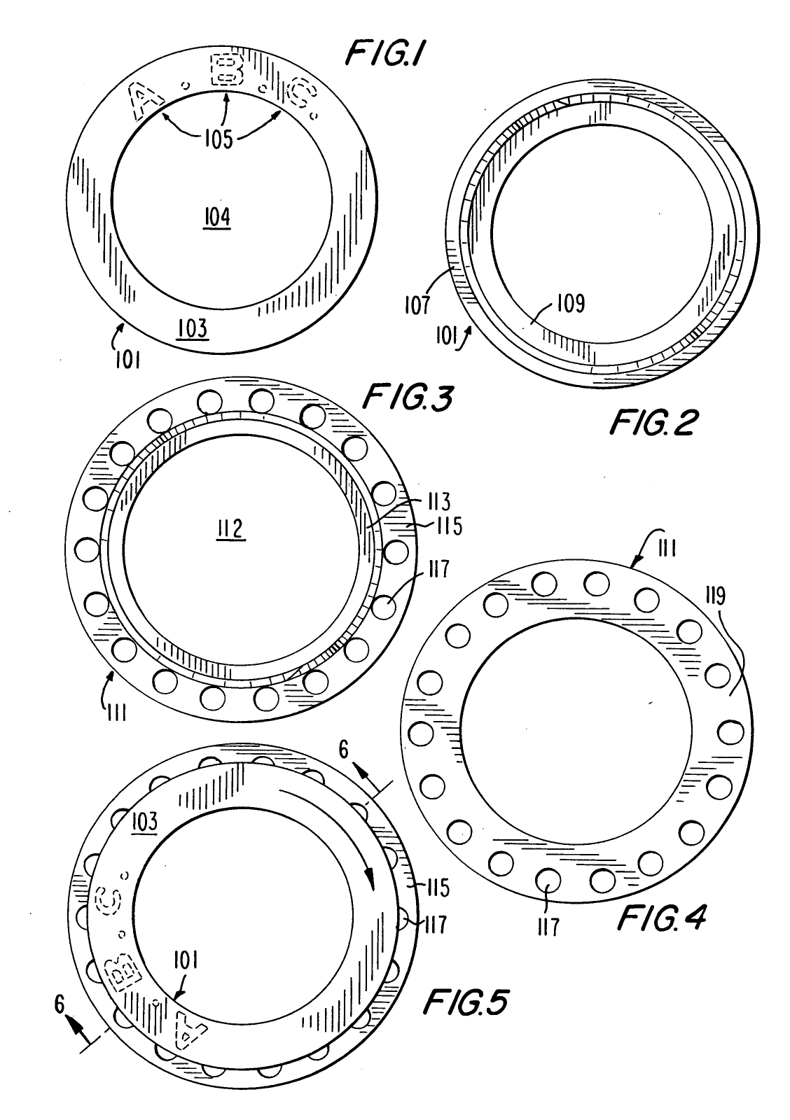

Bezel 101, as best in FIG. 2, also includes an annular back surface 109 from which an annular extending female member 107 extends (See FIG. 6). Female member 107 of bezel 101 includes a plurality of annular threads 106 (see FIG. 8) formed along the inside surface thereof. Threads 106 of female member 107 are used for selectively rotatably screwing bezel 101 onto a metal support ring, as described hereinbelow.

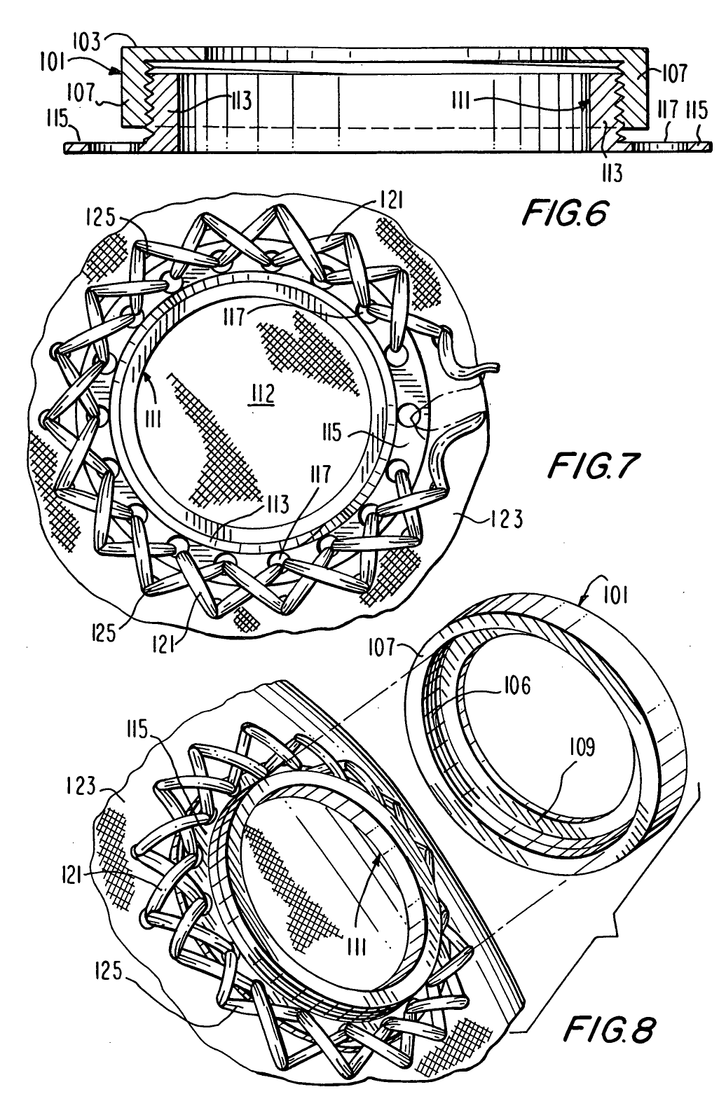

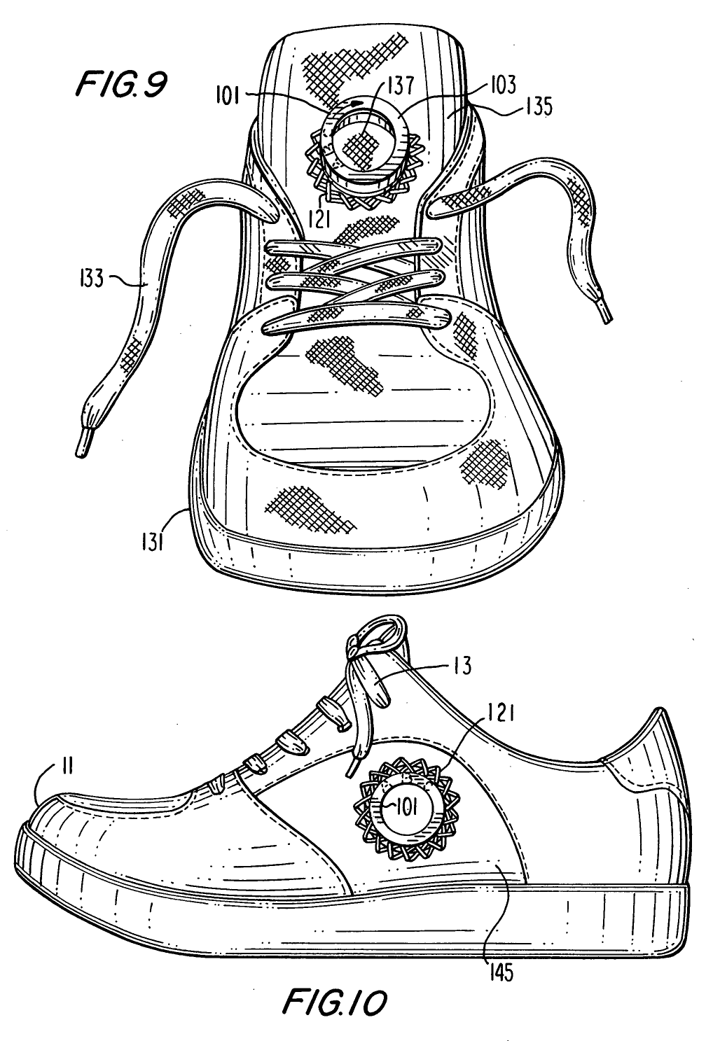

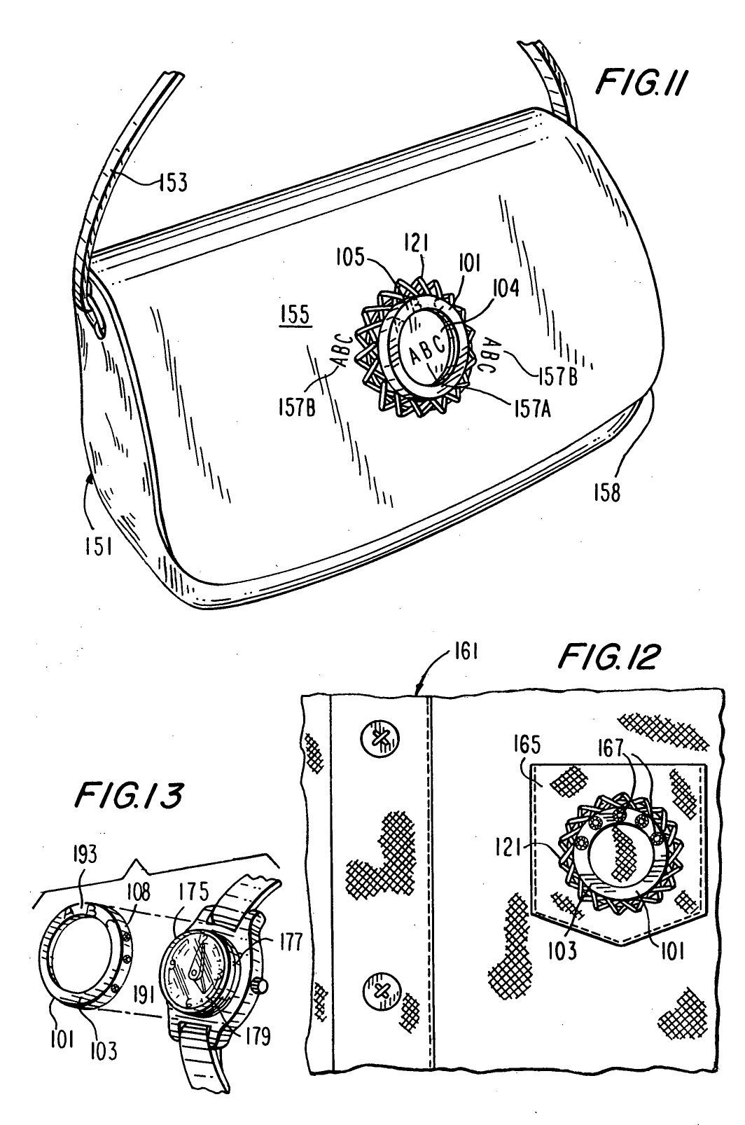

Turning now to FIGS. 3 and 4, a metal support ring to which removable bezel 101 may be rotatably screwed thereon is generally indicated at 111. Ring 111 is formed with an annular flange 115 from which an inner circular male member 113 extends (see FIG. 6). Male member 113 is formed with a plurality of annular threads 114 (see FIG. 8) along the outer surface thereof in order to threadingly engage threads 106 of female member 107 of bezel 101 (see FIGS. 5 and 6). Flange 115 of ring 111 is formed with substantially equally spaced holes through which stitching can run therethrough (FIG. 7). This enables ring 111 to be attached to a portion of fabric or other material such that back surface 119 (FIG. 4) of ring 111 is in facing relationship with the surface of the fabric or material.

Turning now to FIGS. 7 and 8, ring 111 is shown attached to a fabric material 123 by means of stitching 121. In particular, stitching 121 is threaded or otherwise run through holes 117 formed in flange 115 of ring 111. Stitching 121 is also threaded or otherwise run through holes 125 formed in material 123 in order to attach a ring 111 thereto.

Turning now to FIGS. 9 and 10, bezel 101 is shown attached at various locations along sneaker 131. Sneaker 131 is of conventional construction and includes lacing 133, a tongue portion 135 and side walls 145. In FIG. 9, bezel 101 is shown selectively attached along tongue portion 135 by means of the inventive system, while in FIG. 10, bezel 101 is shown attached along one of side walls 145 by the inventive system. In FIG. 9, lettering 137 is shown imprinted on tongue portion 135 and visible through the opening defined by bezel 101.

FIG. 11 shows attachment of bezel 101 by the inventive mechanism to a front panel 155 of pocketbook 151. Pocketbook 151 is of conventional design and includes a strap 153 attached to a body portion 158. Front panel 155 of pocketbook 151 includes lettering 157A and 157B of a complementary design to the lettering imprinted on bezel 101. The lettering 157A is disposed within and is visible through opening 104 of bezel 101. Lettering 157B is disposed outside and around bezel 101.

In FIG. 12, bezel 101 includes a plurality of decorative stones formed along top surface 103 in order to provide a unique decorative appearance. Bezel 101 is shown selectively attached to a pocket 165 of a garment 161 by means of the inventive mechanism.

In FIG. 13, bezel 101, which includes a plurality of decorative stones 191 along side surface 108 and lettering 143 along top surface 103, is shown removably attachable to a watch 171. In particular, watch 171 comprises a watch band 173, a dial 179 and a circularly configured case 175. Case 175 is defined by an annular ring 177 having a series of annular threads formed therealong that are engageable with threads 106 (see FIG. 8) of bezel 101 so that bezel 101 can be selectively screwed on and off case 175 of watch 171. Thus, bezel 101 is removable from watch 171 so that it can also be attached to a sneaker pocketbook or item of clothing; the reverse, of course, is also possible, in accordance with the invention.

In accordance with the inventive system, a plurality of bezels each having a unique decorative or visual presentation (lettering, jewelry stones, color, design, etc.) can be used, thus enabling the consumer to selectively apply a different bezel to a footwear, clothing or an accessory item, depending on the specific visual presentation that is desired and/or depending on the occasion that the footwear, apparel or accessory item is to be used.

Significantly, and as previously described with respect to FIGS. 9 and 11, a design element, such as lettering, may be applied to a location along the footwear, apparel or accessory item that is adjacent to or precisely where the inventive bezel is secured, thus enabling a variety of visual presentations. Moreover, such visual presentations may be coordinated in appearance to the visual presentation provided by or depicted on the bezel itself.

It will thus be seen that the objects set forth above, and those made apparent from the preceding description, are efficiently attained, and since certain changes may be made in the products and systems set forth above without departing from the spirit and scope of the invention, it is intended that all matter contained in the above description and shown in the accompanying drawings shall be interpreted as illustrative and not in a limiting sense.

It is also to be understood that the following claims are intended to cover all the generic and specific features of the invention herein described, and all statements of the scope of the invention, which, as a matter of language, might be said to fall therebetween.

1. A system for enhancing the appearance of an apparel or accessory item comprising:
a plurality of bezels each having a unique decorative or visual presentation;
a ring element fixed in position along a location on said apparel or accessory item and capable of selective removable coupling with any of said bezels.

2. The system of claims 1, wherein said ring element includes an outer annular flange that is irremovably mounted to said apparel or accessory item at said location.

3. The system of claim 2, wherein said flange of said ring element is formed with a plurality of holes through which stitching is run therethrough for securing said ring element along said location.

4. The system of claim 1, wherein each of said bezels includes a female member capable of selective attachment to a male member of said ring element.

5. The system of claim 4, wherein said female member of each said bezel is formed with a plurality of inner threads and said male member of said ring is formed with a plurality of outer threads for matingly engaging with the threads of said female member.

6. The system of claim 1, wherein said unique decorative or visual presentation is selected from the group consisting of an arrangement of jewelry stones, imprinted lettering and color.

8. A decorative system comprising:
at least one apparel or accessory item;
a ring affixed in position along a location on said at least one apparel or accessory item;
a plurality of bezels each having a unique decorative or visual presentation with each bezel capable of selective removable coupling with said affixed ring.

9. The system of claim 8, wherein said at least one apparel or accessory item is selected from the group comprising a footwear item, a watch, a handbag and an item of clothing.

10. The system of claim 8, wherein said at least one apparel or accessory item comprises a plurality of different apparel or accessory items with any of said bezels capable of selective removable coupling with the affixed ring of any of said items.

11. The system of claim 8, wherein said ring includes an outer annular flange that is irremovably mounted to said apparel or accessory item at said location.

12. The system of claim 11, wherein said flange of said ring is formed with a plurality of holes through which stitching is run therethrough for securing said ring along said location.

13. The system of claim 16, wherein each said bezel includes a female member capable of selective attachment to a male member of said ring element.

14. The system of claim 8, wherein said at least one apparel or accessory item has a unique decorative or visual presentation disposed at least adjacent to said location and complementary in appearance to the decorative or visual presentation of at least one of said bezels.

15. A system for enhancing the appearance of an apparel or accessory item comprising:
a plurality of bezels each having a unique decorative or visual presentation;
coupling means fixed along a location on said apparel or accessory item for enabling selective removable attachment of any of said bezels to said apparel or accessory item at said location.

16. The system of claim 15, wherein said coupling means comprises a ring affixed in position along said location and designed for selective mating engagement with any of said bezels.

17. A decorative system comprising:
at least one apparel or accessory item;
a plurality of bezels each having a unique decorative or visual presentation;
a coupling element fixed along a location on said at least one apparel or accessory item for enabling selective removable attachment of any of said bezels to said apparel or accessory item at said location.

18. The system of claim 17, wherein said coupling means comprises a ring affixed in position along said location and designed for selective mating engagement with any of said bezels.

19. The system of claim 17, wherein said at least one apparel or accessory item has a unique decorative or visual presentation disposed at least adjacent to said location and complementary in appearance to the decorative or visual presentation of at least one of said bezels.

20. The system of claim 17, wherein said at least one apparel or accessory item comprises a plurality of different apparel or accessory items with any of said bezels capable of selective attachment to any of said items by means of said fixed coupling element.
